(19) United States
(12) Patent Application Publication
(10) Pub. No.: US 2003/0196543 A1
(43) Pub. Date: Oct. 23, 2003

(54) Mine sweeping and clearing system for land mines

(75) Inventors: Hans Moser, Bergen (DE); Detlev Eckhoff, Martensrade (DE); Hermann Grosch, Nienhagen (DE); Klaus Neugebauer, Hilgert (DE)

Correspondence Address: VENABLE, BAETJER, HOWARD AND CIVILETTI, LLP, P.O. BOX 34385, WASHINGTON, DC, 20043-9998, US

(73) Assignee: Rheinmetall Landsysteme GmbH, Kiel (DE)

(21) Appl. No.: 10/407,907

(22) Filed: Apr. 7, 2003

(30) Foreign Application Priority Data
Apr. 6, 2002 (DE) DE 102 15 220.9

(51) Int. Cl. B64D 1/04; F41F 5/00

(52) U.S. Cl. 89/1.13

(57) ABSTRACT

A mine sweeping and clearing system (100) includes one or two carrier vehicles (1, 10, 11), with an advance-detonation device (2) for detonating mines located at or near the surface, and a mine-sensor assembly (3) that utilizes various physical effects to identify unambiguously as mines and locate deeper-buried mines. An additional flail (7) then detonates the identified and located mines.

### CROSS REFERENCE TO RELATED APPLICATIONS

This application claims the priority of German Patent Application DE 102 15 220.9, filed Apr. 6, 2002, which is incorporated herein by reference.

### BACKGROUND OF THE INVENTION

The invention relates to a mine sweeping and clearing system for land mines.

In many countries, land mines pose a permanent threat to civilians and military personnel. The mines used are antipersonnel mines and anti-tank mines that are positioned on the ground surface, at the surface, and buried, typically up to 30 cm deep. The mines employ a wide variety of ignition and detonation mechanisms. The majority of the mines used worldwide have mechanical igniters, which detonate the mine on contact, or are activated by a trip wire. To eliminate the threat that mines pose to people, the mines must at least be cleared from areas inhabited by people. For this purpose, mechanical and pyrotechnical clearing systems are used to augment manual clearing means.

FR 914 285 describes a simple, mechanical clearing system.

EP 0 618 423 A1 discloses a tracked vehicle that has been converted into a mine-clearing vehicle. This vehicle transports the mine in front of a milling drum, where it is exploded by the exertion of pressure. This type of vehicle may be remote-controlled, if desired.

EP 0 365 264 A1 discloses a flail system, which can be set by a height sensor having a distance sensor, and is located in the front of a vehicle. This sensor aids in controlling the height of the flail.

DE 196 33 186 C2 describes a mine-clearing system based on a modified armored vehicle. A front attachment that supports a milling roller and pivots about a horizontal axis is mounted on the front of the vehicle. A milling roller that acts as a secondary search device is mounted on the rear.

DE 88 07 421 U1 discloses a flail device.

Further mine-clearing devices are described in DE 26 32 568 A1 and DE 24 30 709 A1.

DE 44 41 075 C1 also involves a mine-clearing device employing a front-mounted attachment. In this instance, magnets are provided in the region of a milling drum for selecting metal parts.

In addition, there are sweeping and clearing systems in which sensors detect and partially localize mines. The detected mines are subsequently and purposefully cleared.

For example, DE 195 14 569 A1 describes a sweeping and clearing device for land mines, the device being installed in a vehicle. In this device, a rotating metal detector detects the mine position, and mobile pick-up devices can deploy an impact charge. The device only sweeps for metallic mines. It cannot detect non-metallic mines.

DE 42 42 541 A1, a document with the same generic subject matter as the present application, discloses a device for locating underground ammunition. For automatically locating and mapping ammunition over a large surface area without endangering the sweeping crew, the invention proposes mounting the ground-sensing sensors on a separate, lightweight, unmanned, remote-controlled vehicle (daughter vehicle) in an ammunition-infested area. Aerials, that is, antennas, of a ground-based radar device, magnetic sensors and a camera for ground observation, all of which are mounted to a lateral extension arm, are provided as sensors. The clearing of mines is not described here.

DE 20 52 900 A1 discloses a mine-clearing device for land mines. The proposed solution is employed in clearing pressure mines, noise mines and magnetic mines. The vehicle speed is variable, and is independent of the roller speed of an attached device. Striking rollers and pressure rollers initiate the detonation, which ensures that all of the modules withstand these brief work pressures. There is no reference to the sensing process.

The requirements placed on such systems include effective clearing, as well as a high detection quality with a low false-alarm rate and the highest possible surface-area coverage. False alarms occur, for example, when metallic fragments are detected and marked for clearing.

### SUMMARY OF THE INVENTION

It is an object of the invention to provide a mine sweeping and clearing system that precludes such false alarms and assures a high detection quality with high surface-area coverage.

The invention is based on the idea of providing a vehicle-mounted advance-detonation device for detonating mines located at or near the surface, and a sensor assembly that utilizes various physical effects so that underground mines are unambiguously identified as mines and located. In other words, the mechanical advance-detonation device comprises, for example, flail elements that detonate all of the mines at the surface, such as armored mines, anti-tank mines and fragment mines detonated by trip wires, that are located in or near the vehicle's path. The sensor assembly locates the hidden, deeper-buried mines. This locating procedure then effects a purposeful clearing by the mine sweeping and clearing system.

An additional flail, which is preferably functionally connected with the advance-detonation device, detonates these located, deeper-buried mines. The carrier vehicle is then oriented with respect to a located deeper-buried mine such that at least one such additional flail is located directly above the mine, while the carrier vehicle remains at a distance from it. The additional flail detonates the mine.

The sensors include optoelectronic sensors, ground-based radar (GPR), X-ray reflectors, electromagnetic (EMI=Electromagnetic Impulse) sensors and/or explosives detectors, such as TNA (Thermal Neutron-Activation) sensors, IMS sensors (Ion Mobility Spectrometers), or NQR (Nuclear Quadrupole Resonance) sensors.

The optoelectronic sensors are imaging sensors that evaluate features of mines and are used for automatic detection. For hidden mines, secondary features, such as changes in the ground cover and/or the thermography of the surface, can preferably be assessed. Ground-based radar can also be used to detect buried mines, in this case mines without metal components, because mines in the earth's surface change the dielectricity.

Electrochemical sensors, IMS sensors, TNA sensors and NQR sensors are especially useful in recognizing buried mines by detecting explosives. TNA sensors and NQR sensors stimulate the mine with neutrons or electromagnetic signals, and evaluate the reflected signal responses. IMS sensors and electrochemical methods detect explosives by assessing the mobility of the molecules of substances, or the change in the electrical conductivity of substances, as caused by the molecules.

A direct, combined evaluation of the sensor data also permits a highly precise determination of the location and position of the mines for clearing. The coordinate systems employed by the sensors are directly adjusted in accordance with, and/or are combined with, for example, GPS receivers and inertial sensors. The individual sensor data are transformed precisely into a resulting unified coordinate system for determining the location and position of the detected mines.

The mine-sweeping sensor assembly can be set such that only specific groups of mines having predetermined distinguishing features are detected. This allows the sensors to be set only to search for and detect, for example, large, buried mines, such as anti-tank mines.

If a mechanical advance-detonation device is mounted on a one-piece, for example, one-vehicle, mine sweeping and clearing system, the chassis of the system is configured to prevent the mines that have not been detonated by the advance-detonation device from being detonated by the chassis.

The mine sensor assembly is disposed behind the mechanical advance-detonation device. The mine sweeping and clearing system can preferably be remote-controlled, and can comprise one carrier vehicle or two carrier vehicles.

In a two-part, that is, two-vehicle, mine sweeping and clearing system, the sensor assembly is mounted so far forward in the front region of one of the two vehicles that, after a mine has been detected, the vehicle can stop so that the chassis does not pass over the mine.

The advance ground-impact energy of the detonation device, such as a flail system, as described in DE 197 81 871 T1, is set such that all of the mines and mine-detonation devices located above the search depth are detonated, because the advance detonator need not detonate any deeper anti-tank mines. All that is desired for the advance detonation is for the flail elements to impact a mine, which advantageously does not destroy the structure of the ground beneath. The flail system is preferably mounted directly on the vehicle, but can also be used on an independent carrier vehicle. The flail elements, like the additional flail, are preferably chains, each having a percussive element. The advantage of the flail system is that the vegetation of the subsurface is flattened, and disappears. This prevents damage to the sensors by stones, vegetation, etc.

In a preferred embodiment, the flail system has at least one the additional flails, which is mounted to the left and/or right of the flail elements on a flail shaft, by way of a coupling to the drive motor. The additional flail is decoupled from the drive motor during the operation of the primary flail system.

Limiting the scope of objects to be searched exclusively to buried mines having a minimum size and a minimum depth contributes to a reduction in the false-alarm rate, and a high detection rate. The detection of metallic fragments, for example, does not result in a mine identification.

### BRIEF DESCRIPTION OF THE DRAWINGS

The invention is described in detail by way of an exemplary embodiment shown in the drawing, in which:

FIG. 1 is a perspective view of a mine sweeping and clearing system having a carrier vehicle for searching for and clearing mines;

FIG. 2 is a perspective view of a mine sweeping and clearing system comprising two carrier vehicles; and

FIG. 3 is a perspective view of an advantageous embodiment that includes a further mine-sweeping sensor assembly.

### DETAILED DESCRIPTION OF THE INVENTION

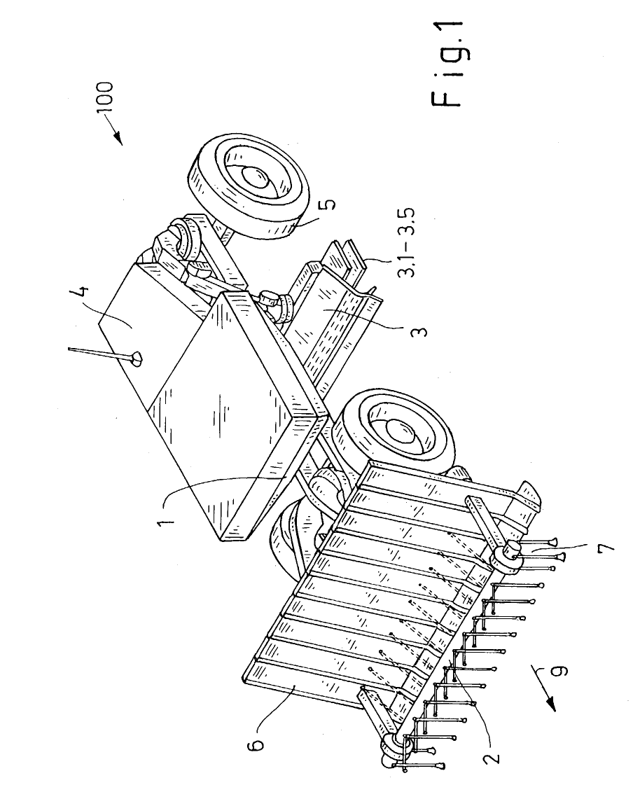

FIG. 1 illustrates a mine sweeping and clearing system 100 having a carrier vehicle 1 with a mechanical advance-detonation device 2 having flail elements 2.1, a mine-sweeping sensor assembly 3, also called a sensor assembly, and a sensor and evaluation circuit 4. The carrier vehicle 1 preferably has low-pressure tires 5 and a protective shield 6 that is mounted behind the advance-detonation device 2 for protecting the sensor assembly 3. If the advance-detonation device 2 and the sensor assembly 3 are integrated into a single vehicle 1, at least the chassis (including wheel operating equipment and the chain operating equipment) is configured such that the mines that have not been detonated by the advance-detonation device 2 also cannot be detonated by the chassis. The sensor assembly 3 is preferably mounted in the rear region of the vehicle 1.

In a preferred embodiment, it has proven advantageous to mount additional flails 7 to the right and/or left of the drive shaft of the advance-detonation device 2. These additional flails 7 allow a mine that has been detected to be purposefully detonated and destroyed, as will be explained hereinafter.

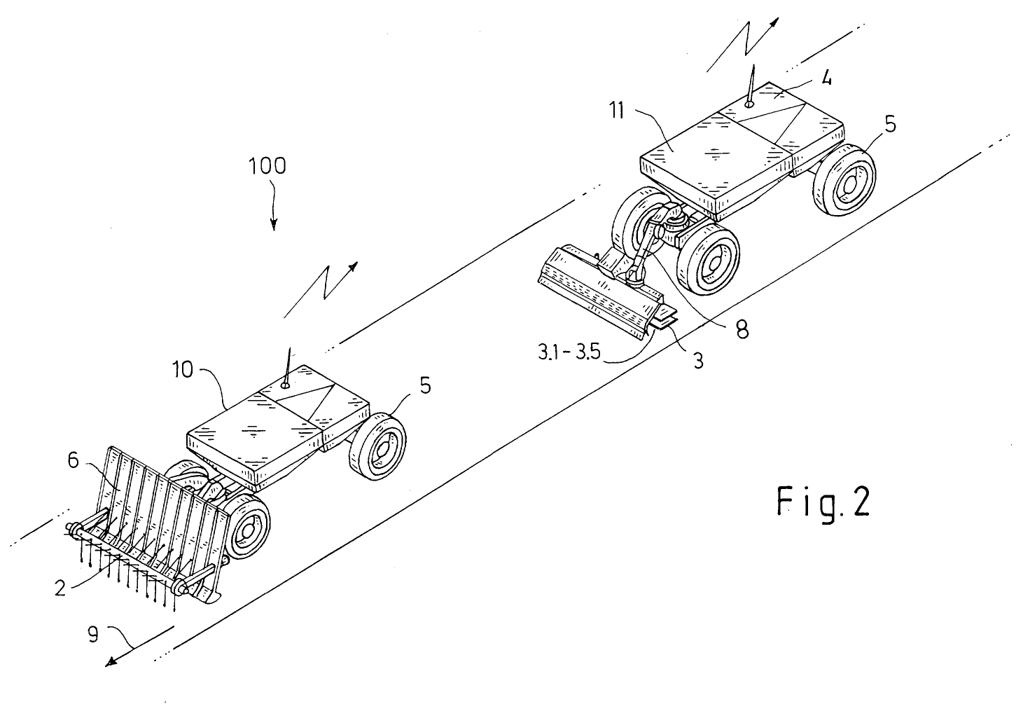

FIG. 2 illustrates the separate mounting of the individual components on two carrier vehicles 10, 11. The advance-detonation device 2 is mounted on the first carrier vehicle 10, which travels in the direction 9. Here, the chassis of the carrier vehicle 10 is configured such that the chassis cannot detonate mines that have not been detonated by the advance-detonation device 2.

In the associated, second carrier vehicle 11, the sensor assembly 3 is mounted so far to the front of the vehicle 11 that the vehicle can preferably be stopped after a mine has been detected, so the chassis does not pass over the mine. For this purpose, the carrier vehicle 11 includes a pivoting sensor-assembly pivot arm 8, on which the sensor assembly 3 is mounted. The sensor and evaluation circuit 4 is additionally integrated into the second carrier vehicle 11.

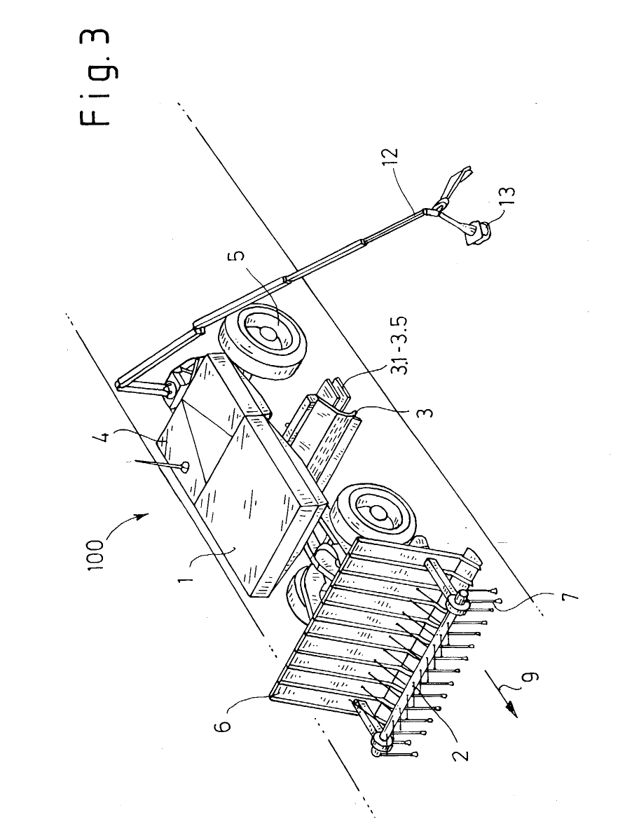

FIG. 3 depicts a further embodiment. Here, a multifunctional manipulator, a laterally pivoting arm 12, is provided with an additional sensor assembly 13 (to be explained below).

The sensor assembly 3 comprises a at least sensor that utilizes any of various physical effects, such as an optoelectronic sensor 3.1, a ground-based radar 3.2, an X-ray reflection sensor 3.3, and an EMI 3.4 and/or an explosives detector 3.5. It is preferred that the sensor assembly 3 comprise a plurality of sensors, even all of the mentioned sensors.

A flail system is provided as the advance-detonation device 2. This system has impact or flail elements 2.1.

The principle of the effective mine sweeping and clearing system 100 according to FIGS. 1 through 3 lies in destroying or detonating all mines at or near the earth's surface with the mechanical advance-detonation device 2, and setting the sensor assembly 3 such that it is optimized for detecting buried mines.

The advance detonation is effected by the striking of the flail elements 2.1 of the flail system 2. The sensor assembly 3 is preset to detect only specific groups of mines possessing predetermined properties. These properties can include the position of the mine beneath the earth's surface, with a minimum depth x, and a minimum mine size or volume.

If the sensor assembly 3 has detected and localized a mine according to FIG. 1, the flail system 2 is deactivated. The vehicle 1 is then moved so that one of the additional flails 7 is positioned directly above the mine. Afterward, the additional flail 7 is coupled to and set into rotation by a flail motor (not shown in detail). The flail system 2 is then lowered gradually into the ground until the buried mine is destroyed. The full drive power of the flail system 2 is available for the additional flail 7, thereby assuring fast clearing.

In the embodiment according to FIG. 2, when a mine has been detected, the carrier vehicle 10, with its advance-detonation device 2 and additional flails 7, is sent to the corresponding position, which is preferably effected via remote control, with the ascertainment of the location being transmitted as information from the carrier vehicle 11 to the first carrier vehicle 10. The detonation is then effected as described above.

An embodiment according to FIG. 3 serves in improving the performance of the sensor assembly 3 even further. The additional sensor assembly 13 mounted on the laterally pivoting arm 12 can purposefully sweep uneven surfaces, surfaces that have structures on them and areas distinguished by the presence of vegetation and stones. Examples include roadsides or ditches, trees and bushes in the immediate vicinity, bridge access roads, etc. This additional sensor assembly 13 has a modular construction, and the width of its sweep can be optimized for a particular job.

In a preferred embodiment, the sensor data are evaluated directly. This evaluation is combined with a location referencing that factors in the vehicle-specific and absolute coordinates. The sensor-coordinate systems are ascertained directly. Within the scope of the evaluation, individual sensor data are precisely transformed into a unified coordinate system that takes into account the location and position.

The invention now being fully described, it will be apparent to one of ordinary skill in the art that many changes and modifications can be made thereto without departing from the spirit or scope of the invention as set forth herein.

What is claimed is:

1. A mine sweeping and clearing system, comprising:
an advance-detonation device (2) for detonating mines located at or near the ground surface in the region of the mine sweeping and clearing system (100); and
sensors (3.1-3.5) for locating deeper-buried mines,
wherein the sensors utilize various physical effects, the sensors being assembled to form a sensor assembly (3) that detects and locates the deeper-buried mines.

2. The mine sweeping and clearing system according to claim 1, wherein the sensors (3.1-3.5) include at least one of the following: an optoelectronic sensor (3.1), a ground-based radar (3.2), an X-ray reflector (3.3), an electromagnetic sensor, (3.4) and an explosives detector (3.4).

3. The mine sweeping and clearing system according to claim 2, wherein the sensors include at least one explosives detector (3.5) from the following group: a TNA sensor, an IMS sensor and an NQR sensor.

4. The mine sweeping and clearing system according to claim 1, wherein a direct combination evaluation of the sensor data is effected in a sensor and evaluation circuit (4), in which a highly precise ascertainment of the location and position of the mines takes place for clearing them; the sensor-coordinate systems are specified directly for an adjustment and/or a combination with a GPS receiver or inertial sensors, and the individual sensor data are precisely transformed into a unified coordinate system in the sensor and evaluation circuit (4), with consideration of the location and position.

5. The mine sweeping and clearing system according to claim 1, wherein the mine-sweeping sensor assembly (3) can be set such that only specific groups of mines having predetermined distinguishing features are detected.

6. The mine sweeping and clearing system according to claim 5, wherein the distinguishing features are a minimum depth x of the mine beneath the earth's surface and a minimum mine size.

7. The mine sweeping and clearing system according to claim 1, wherein the system comprises one or two carrier vehicles (10, 11).

8. The mine sweeping and clearing system according to claim 7, wherein a mechanical advance-detonation device (2) is mounted on the front of the system.

9. The mine sweeping and clearing system according to claim 8, wherein the system (100) has a chassis configured such that the mines that have not been detonated by the advance-detonation device (2) also cannot be detonated by the chassis.

10. The mine sweeping and clearing system according to claim 8, wherein the sensor assembly (3) is disposed behind the mechanical advance-detonation device (2).

11. The mine sweeping and clearing system according to claim 8, wherein the system comprises two carrier vehicles, one positioned in front of the other, and the sensor assembly (3) is mounted sufficiently far to the front of said other carrier vehicle (11) that, after a mine has been detected, said other carrier vehicle (11) can stop and not pass over the mine.

12. The mine sweeping and clearing system according to claim 11, wherein the sensor assembly (3) is mounted on a pivot arm (8).

13. The mine sweeping and clearing system according to claim 8, wherein the advance-detonation device (2) is a flail system having flail elements.

14. The mine sweeping and clearing system according to claim 13, wherein the advance-detonation device (2) has an additional flail (7).

15. The mine sweeping and clearing system according to claim 14, wherein the additional flail (7) is mounted on an end of a shaft of the advance-detonation device (2), by way of a coupling to a drive motor.

16. The mine sweeping and clearing system according to claim) 1, wherein of the advance-detonation device (2) has a ground-impact energy set such that all mines located above a predetermined depth (x) are detonated and all mine-detonation devices located above a predetermined depth (x) are actuated.

17. The mine sweeping and clearing system according to claim 13, wherein striking by the flail elements effects the advance detonation.

18. The mine sweeping and clearing system according to claim 1, wherein the system further comprises a laterally pivoting arm and an additional, modular sensor assembly (13) mounted on the laterally pivoting arm (12).
